(19) United States
(12) Patent Application Publication
(10) Pub. No.: US 2026/0196535 A1
(43) Pub. Date: Jul. 9, 2026

(54) VOLUTE FOR A FLOW MACHINE FOR A FUEL CELL SYSTEM OF A VEHICLE, IN PARTICULAR A UTILITY VEHICLE, FLOW MACHINE, FUEL CELL SYSTEM, AND VEHICLE

(71) Applicant: ZF CV Systems Global GmbH, Bern (CH)

(72) Inventors: Thorge Kentschke, Hannover (DE); Florian Steinberger, Aulendorf (DE); Raphael Zwick, Wangen (DE)

(21) Appl. No.: 19/554,490

(22) Filed: Mar. 2, 2026

Related U.S. Application Data
(63) Continuation of application No. PCT/EP2024/073040, filed on Aug. 16, 2024.

(30) Foreign Application Priority Data
Sep. 15, 2023 (DE) 10 2023 125 070.1

(51) Int. Cl. H01M 8/04111

(52) U.S. Cl. CPC H01M 8/04111; H01M 2250/20

(57) ABSTRACT

A volute is for a flow machine for a fuel cell system of a vehicle, in particular a utility vehicle. The volute has: a flow inlet for supplying the volute with an air flow which includes fluid constituents; and a helical flow body for guiding the air flow; wherein the flow body has an outlet opening for discharging the fluid constituents, which are separated from the air flow within the flow body, out of the flow body.

### CROSS-REFERENCE TO RELATED APPLICATIONS

This application is a continuation application of international patent application PCT/EP2024/073040, filed Aug. 16, 2024, designating the United States and claiming priority from German application 10 2023 125 070.1, filed Sep. 15, 2023, and the entire content of both applications is incorporated herein by reference.

### TECHNICAL FIELD

The disclosure relates to a volute for a turbomachine for a fuel cell system of a vehicle, in particular a utility vehicle, wherein the volute has: a flow inlet for applying an air flow including fluid constituents to the volute; and a spiral-shaped flow body for guiding the air flow. The disclosure also relates to a turbomachine for a fuel cell system of a vehicle, in particular a utility vehicle, including a volute, a fuel cell system including a turbomachine and a fuel cell stack which can be operatively connected to the turbomachine, and a vehicle, in particular a utility vehicle, including a fuel cell system.

### BACKGROUND

Turbomachines and therefore volutes and fuel cell systems of this type are known in the prior art. Here, such a turbomachine typically includes an impeller wheel or rotor. A spiral housing, also referred to as volute, is arranged around the impeller wheel. Air passes through the volute and the speed of the air is changed, depending on the application, by passing through the volute until it emerges from the volute.

In fuel cell systems, a compressor is used to draw in air, compress it and feed it to a cathode-side fuel cell inlet of a fuel cell for carrying out the fuel cell reaction. The compressed substance mixture passes through the stack or the stacks or fuel cell stacks of the fuel cell. The substance mixture remaining in the fuel cell stack after the reaction exits again as a fluid flow on the cathode side from a cathode-side fuel cell outlet of the fuel cell stack. The fluid flow, also referred to as the air flow, can also include liquid constituents, for example in the form of water droplets.

This fluid flow usually still has an overpressure with respect to the surroundings and is therefore used in most fuel cell systems to drive an expander shaft of an expander or of a turbine. In the expander, the air flow emerging on the outlet side can be expanded to ambient pressure, and the energy delivered to the expander shaft is usually converted into electrical energy if the expander is connected to a generator, and/or drives the compressor entirely or partially if the compressor and the expander have the same shaft.

DE 20 2022 103 117 U1 discloses a housing for receiving a rotor having a compressor wheel and a shaft, in particular a housing of a charger for an internal combustion engine or a fuel cell.

DE 10 2020 202 126 A1 discloses a gas feed device having at least one compressor impeller which is rotatable in a compressor volute and which is connected by a shaft fixedly for conjoint rotation to a turbine impeller which is rotatable in a turbine volute, and having a bearing arrangement for the shaft.

One technological challenge is the handling of water and/or liquid constituents in the turbomachine, that is, in particular in a flow body of a fuel cell turbocompressor. Typically, the air flow emerging from the fuel cell stack on the cathode side has a comparatively high air humidity of approximately 100%.

In this case, liquid constituents such as, for example, droplets and/or a liquid film on the impeller wheel of the expander can lead to erosion and/or corrosion of the impeller wheel, which can ultimately lead to influencing and/or to damage to the turbomachine. Therefore, possible liquid constituents have to be removed, in particular in the immediate vicinity of the impeller wheel.

It is known from the prior art to provide a separate liquid filter or separator in order to separate liquid constituents from an air flow flowing in the flow body.

### SUMMARY

It is an object of the disclosure to provide a liquid separator which is effective with regard to the installation space and the costs.

The aforementioned object is, for example, achieved by various volutes according to the disclosure. The aforementioned object is, for example, also achieved by various turbomachines according to the disclosure.

According to an aspect of the disclosure, a volute for a turbomachine for a fuel cell system of a vehicle, in particular a utility vehicle, is provided, wherein the volute has: a flow inlet for applying an air flow including fluid constituents to the volute; and a spiral-shaped flow body for guiding the air flow; wherein the flow body has a discharge opening for discharging fluid constituents, separated from the air flow within the flow body, from the flow body.

The volute has the flow inlet. Via the flow inlet, the volute or the flow body thereof can be acted upon by the air flow, in particular by the air flow exiting from a cathode of a fuel cell stack on the outlet side. The flow body is configured to be flowed through by the air flow. Here, the air flow can pass through the volute in accordance with the geometry of the flow body.

It has been recognized here that it is possible to configuration the volute in such a way that a liquid separator is functionally integrated. Here, use is made of the deflection of the air flow which takes place in the volute as a result of the spiral shape of the flow body. As a result of the deflection of the air flow including the fluid constituents, a centrifugal force can act on the fluid constituents and thus separate them from the air flow. Here, the fluid constituents can be deposited as droplets and/or film on a surface of the flow body and can thus be separated from the air flow. The spiral housing has the discharge opening, via which the fluid constituents can be discharged.

The volute thus allows reliable separation of fluid constituents from the air flow. As a result of the use of the separation of the fluid constituents from the air flow that takes place as a result of the deflection, an additional separator and/or filter can be dispensed with. As a result, installation space and costs can be saved. In addition, a possible pressure drop through a filter, which impairs a degree of efficiency, can be avoided.

According to various embodiments, the turbomachine includes a turbine. Here, the turbine denotes a rotating turbomachine which, when the air flow is expanded, brings about a rotation of a shaft and thus converts energy from the air flow into rotational energy of the shaft. Here, it has been recognized that such an expander can be a main application case for the volute, since such an expander is typically arranged downstream of a fuel cell stack on the cathode side and is thus typically subjected to an air flow having a comparatively high moisture content.

According to various embodiments, the flow body has a diameter, and the diameter decreases in the downstream direction. Here, the diameter can define the cross section of the flow body, that is, an extent of the flow body perpendicular to the flow direction or circumferential direction. The downstream decrease in the diameter makes it possible to provide an air mass flow which is constant in the circumferential direction, and can thus enable uniform separation of the fluid constituents from the air flow. Here, the flow body is not restricted to a circular cross section. The flow body can also have another, for example angular, in particular square, oval and/or elliptical, cross section, the cross-sectional area of which decreases in the downstream direction.

According to various embodiments, the volute defines an axis; the flow body is arranged wound around the axis; and the discharge opening is arranged on a radially outer annular portion of the flow body with respect to the axis. It has been recognized here that the fluid constituents are deflected in the radially outer direction by the movement of the air flow and are separated there. Arranging the discharge opening in the radially outer annular portion can therefore promote the discharge of the fluid constituents.

According to various embodiments, the flow body has a plurality of discharge openings arranged sequentially in the flow direction. It is thus possible to discharge liquid at a plurality of points of the flow body. In particular, it is possible for fluid constituents having a decreasing typical size to be able to be separated in the flow direction or in the circumferential direction.

According to various embodiments, the volute has an air return element for again receiving an air flow part conducted into the discharge opening. Thus, downstream of the discharge openings, that is, for example, in a possible collection chamber and/or in a region of the discharge opening, it is possible to avoid a comparatively high pressure and/or accumulation of air, which can be detrimental to a separation and/or discharge of the fluid constituents.

According to various embodiments, the volute has a separating structure arranged in the flow body for separating fluid constituents from the air flow and for guiding the fluid constituents to the discharge opening. It has been recognized here that it is possible to configure a surface of the flow body to guide the fluid constituents in the direction of the discharge opening. For this purpose, the flow body has the separating structure. The separating structure can include, for example, channels, depressions, grooves and/or other fluid-guiding elements. The separating structure can provide positive guidance from radially on the inside to the outside toward the discharge opening. The separating structure can be configured to receive and remove a liquid film.

According to various embodiments, the volute has an annular channel arranged at the flow inlet. The annular channel allows liquid to be collected from a pipe system between the flow inlet and the fuel cell or the fuel cell stack, and thus allows a first separation of fluid constituents and air. The annular channel can be arranged obliquely with respect to the circumferential direction and/or can provide guidance of the liquid separated in the annular channel into a collecting container and/or for diverting.

According to various embodiments, the volute has a valve for controlling the discharge of fluid constituents from the discharge opening. A separation of fluid constituents can be controlled by the valve.

According to various embodiments, the volute has a diverting arrangement arranged outside the flow body for diverting fluid constituents discharged from the discharge opening. The diverting arrangement can be, for example, a channel which is arranged between the discharge opening and a collecting container and through which fluid constituents can be discharged from the flow body via the discharge opening and the diverting arrangement into the collecting container.

According to various embodiments, the discharge opening is arranged in the assembled state in such a way that the fluid constituents are guided to the discharge opening and/or discharged from the discharge opening in a manner assisted by gravity. It is thus possible to assist a discharge of the fluid constituents. The fluid constituents can be guided to the discharge opening and/or discharged from the discharge opening in a manner assisted by gravity if the discharge openings are arranged in a lower region of the flow body or of the volute in the assembled state.

According to one aspect of the disclosure, a turbomachine for a fuel cell system of a vehicle, in particular a utility vehicle, including an above-described volute is provided. The turbomachine or the volute of the turbomachine can have one or more of the features of the volute that are described above as optional and/or advantageous, in order to achieve an associated technical effect.

According to one aspect of the disclosure, a fuel cell system, Including an above-described turbomachine and a fuel cell stack which can be operatively connected to the turbomachine is provided. The fuel cell system, the turbomachine or the volute of the turbomachine can have one or more of the features of the volute that are described above as optional and/or advantageous, in order to achieve an associated technical effect.

According to one aspect of the disclosure, a vehicle, in particular a utility vehicle, including an above-described fuel cell system is provided. The vehicle, in particular the utility vehicle, the fuel cell system, the turbomachine or the volute of the turbomachine can have one or more of the features of the volute that are described above as optional and/or advantageous, in order to achieve an associated technical effect.

### BRIEF DESCRIPTION OF DRAWINGS

The invention will now be described with reference to the drawings wherein:

FIG. 1 shows a schematic illustration of a vehicle, in particular a utility vehicle, according to an embodiment of the disclosure; and,

FIG. 2 shows a schematic illustration of a volute according to an embodiment of the disclosure.

### DETAILED DESCRIPTION

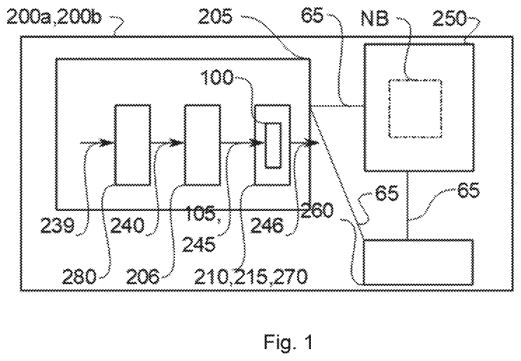

FIG. 1 shows a schematic illustration of a vehicle 200a, in particular a utility vehicle 200b, according to an embodiment of the disclosure.

The vehicle 200a, in particular the utility vehicle 200b, is referred to below as vehicle 200a, 200b. The vehicle 200a, 200b is, for example, a land-based vehicle, in particular a tractor vehicle and/or a trailer vehicle of a multi-unit vehicle, a single-unit vehicle and/or a bus.

The vehicle 200a, 200b has a fuel cell system 205, an energy storage device 260 and an electric drive 250. The fuel cell system 205 is configured to provide electrical energy 65 to the energy storage device 260. The energy storage device 260 is, for example, a rechargeable energy storage device 260 and serves as a buffer battery for buffer storing electrical energy 65. The energy storage device 260 is connected to the electric drive 250 in order to supply the electric drive 250 with electrical energy 65, in order that the electric drive 250 can drive the vehicle 200a, 200b. In addition, the fuel cell system 205 is connected to the electric drive 250 for the direct provision of electrical energy 65. The electric drive 250 can be configured for regenerative braking NB in order to provide electrical energy 65 to the energy storage device 260 in the case of a deceleration of the vehicle 200a, 200b.

The fuel cell system 205 includes a compressor 280, a fuel cell stack 206 and a turbomachine 210 configured as an expander 270 or turbine 215. As schematically indicated in FIG. 1, the compressor 280 is configured to supply a supply air flow 240 to the fuel cell stack 206 on the cathode side. To this end, the compressor 280 is configured to have electrical energy 65 applied to it in order to draw in supply air 239, compress it and supply it to the fuel cell stack 206 as supply air flow 240. The expander 270 is configured to have an exhaust gas flow 245 from the fuel cell stack 206 applied to it in order to convert energy from the exhaust gas flow 245 into electrical energy 65. Alternatively or additionally, the energy of the expander 270 is converted directly into mechanical energy and is used directly for driving (torque assistance) the drive shaft of the compressor 280. The exhaust gas flow 245 is an air flow 105 including fluid constituents 106. The expander 270 or the turbomachine 210 has a volute 100. The air flow 105 passes through the volute 100. Expanded exhaust air 246 exits the expander 270 after the expansion of the exhaust gas flow 245 or air flow 105 by the expander 270.

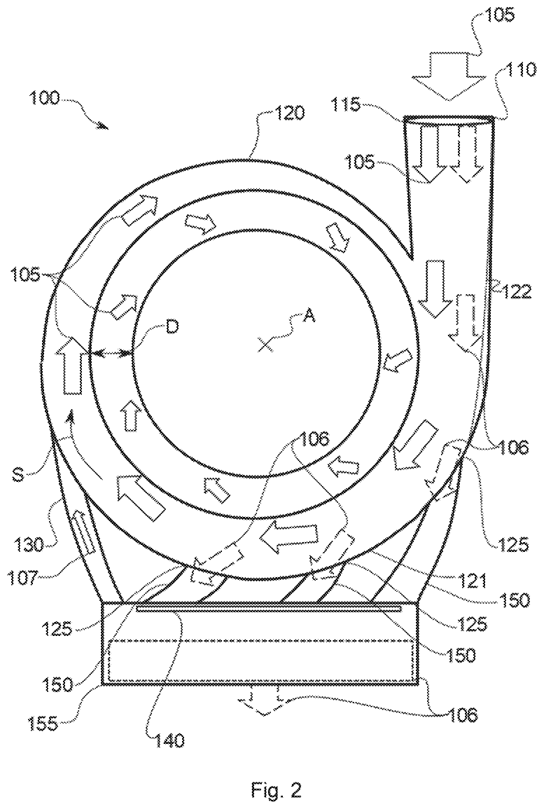

An embodiment of the volute 100 of the turbomachine 210 configured as an expander 270 in FIG. 1 is described with reference to FIG. 2.

FIG. 2 shows a schematic illustration of a volute 100 according to an embodiment of the disclosure. The volute 100 according to FIG. 2 is a volute 100 for a turbomachine 210 for a fuel cell system 205 of a vehicle 200a, 200b. Such a turbomachine 210 and such a vehicle 200a, 200b are described with reference to FIG. 1. FIG. 2 is described with reference to FIG. 1.

The volute 100 according to FIG. 2 has a flow inlet 110 for applying an air flow 105 including fluid constituents 106 to the volute 100. The flow inlet 110 can be connected directly to a cathode-side outlet of a fuel cell stack 206 in order to be acted upon by the air flow 105. In FIG. 2, the direction of movement of the air flow 105 or the gaseous constituents thereof is illustrated by double arrows with a solid line. The direction of movement of the fluid constituents 106 is illustrated by double arrows with a dashed line.

The volute 100 has an annular channel 115 arranged at the flow inlet 110. The annular channel 115 can collect and separate fluid constituents 106 arising or precipitated, in particular, in the connection between the fuel cell stack 206 and the flow inlet 110.

The volute 100 has a spiral-shaped flow body 120 for conducting the air flow 105. The flow body 120 has a circumferential direction which corresponds to a flow direction S of the air flow 105. Here, the volute 100 or the flow body defines an axis A. In the illustration according to FIG. 2, the axis A points into the plane of the image as indicated schematically by a cross. The flow body 120 is arranged such that it is wound around the axis A. The flow body 120 is thus helical and has a curvature. The curvature of the flow body 120 decreases in the flow direction S, or the flow body 120 has a radius which decreases in the flow direction S. The curvature of the volute 100 or of the flow body 120 can be increased in the region of the flow inlet 110 (not shown) in order to achieve an increased deflection of the air flow 105 and thus an increased separation of the fluid constituents 106 from the air flow 105.

Perpendicular to the flow direction S, the flow body 120 has a diameter D. The diameter D defines a cross section of the flow body 120, through which the air flow 105 can flow. The diameter D or the area of the cross section decreases in the downstream direction.

The flow body 120 has a plurality of discharge openings 125 in each case for discharging fluid constituents 106, separated from the air flow 105 within the flow body 120, from the flow body 120. In another embodiment, the flow body 120 can have a discharge opening 125 or any desired number of discharge openings 125 (not shown). Each of the discharge openings 125 is configured to enable fluid constituents 106 which have been separated and/or precipitated in the flow body 120 to be discharged from the flow body 120.

The discharge openings 125 are arranged on a radially outer annular portion 121 of the flow body 120 with respect to the axis A. Here, the discharge openings 125 are arranged in the assembled state in such a way that the fluid constituents 106 are guided to the discharge openings 125 and/or discharged from the discharge openings 125 in a manner assisted by gravity. Here, the fluid constituents 106 can move along the annular portion 121 to the discharge openings 125 as a result of gravity and/or the air flow 105.

The discharge openings 125 are arranged sequentially in the flow direction S. The flow body 120 thus has discharge openings 125 arranged downstream of one another in the flow direction S. The discharge openings 125 can have the same and/or different sizes.

The volute 100 has a separating structure 122 arranged in the flow body 120, as indicated schematically by a line between the flow inlet 110 and the discharge openings 125. The separating structure 122 is configured to separate fluid constituents 106 from the air flow 105 and to guide them to the discharge opening 125. Here, the separating structure 122 is arranged in the radially outer annular portion 121 and/or around the radially outer annular portion 121. The separating structure 122 includes, for example, a channel, a groove and/or a slot, in which fluid constituents 106 can be collected and discharged.

The volute 100 has a diverting arrangement 150 which is arranged outside the flow body 120 for diverting fluid constituents 106 which are discharged from the discharge opening 125, In another embodiment, the volute 100 and/or the discharge opening 125 can be connected fluidically to a diverting arrangement 150. As shown in FIG. 2, the diverting arrangement 150 has one diverting element (not indicated) per discharge opening 125. Here, fluid constituents 106 can be discharged from in each case one of the discharge openings 125 into one of the diverting elements of the diverting arrangement 150. Here, the diverting arrangement 150 can include a plurality of pipelines which each form a diverting element and are arranged between the flow body 120 and a collecting container 155. The diverting arrangement 150 thus includes a channel branched in accordance with the number of discharge openings 125. The diverting arrangement 150 has a curvature which corresponds approximately to the curvature of the flow body 120 in the region of the discharge openings 125. In this way, sufficient separation can be achieved with a comparatively low use of installation space.

The volute 100 is operatively connected to the collecting container 155 or reservoir and/or buffer store. The diverting arrangements 150 are configured to conduct the fluid constituents 106 out of the flow body 120 into the collecting container 155. Here, an air flow part 107 including fluid constituents 106 can branch off from the air flow 105. The air flow part 107 is thus guided out of the flow body 120 and into the collecting container 155 via the diverting arrangement 150. The diverting arrangement 150 and the collecting container 155 are formed in one piece in the example.

The volute 100 has an air return element for again receiving the air flow part 107 conducted into the discharge opening 125. The air flow part 107 is thus conducted back into the flow body 120 via the air return element and can thus flow further through the flow body 120. Here, the air return element can include a pipeline arranged between the collecting container 155 and the flow body 120. In another embodiment (not shown), the volute 100 does not have any air return element. An air return element can be dispensable.

The volute 100 has a valve 140 for controlling the discharge of fluid constituents 106 from the discharge opening 125. Here, in the schematic FIG. 2, the valve 140 is arranged in the collecting container 155, but can also be arranged at the discharge openings 125 (not shown). The valve 140 can selectively allow and/or prevent the discharge of fluid constituents 106 from the discharge openings 125. When a valve 140 is closed, the air flow part 107 flowing through the diverting arrangement 150 and the collecting container 155 is absent.

It is understood that the foregoing description is that of the preferred embodiments of the invention and that various changes and modifications may be made thereto without departing from the spirit and scope of the invention as defined in the appended claims.

### Designations (Part of the Description)

65 Electrical energy
100 Volute
105 Air flow
106 Fluid constituents
107 Air flow part
110 Flow inlet
115 Annular channel
120 Flow body
121 Annular portion
122 Separating structure
125 Discharge opening
130 Air return element
140 Valve
150 Diverting arrangement
155 Collecting container
200a Vehicle
200b Utility vehicle
205 Fuel cell system
206 Fuel cell stack
210 Turbomachine
215 Turbine
220 Fuel cell
239 Supply air
240 Supply air flow
245 Exhaust gas flow
246 Exhaust air
250 Electric drive of the vehicle
260 Energy storage device
270 Expander
280 Compressor
A Axis
D Diameter
NB Regenerative braking
S Flow direction

1. A volute for a turbomachine for a fuel cell system of a vehicle, the volute comprising:
a flow inlet for applying an air flow including fluid constituents to the volute;
a spiral-shaped flow body for guiding the air flow; and,
said spiral-shaped flow body having a discharge opening for discharging from said spiral-shaped flow body the fluid constituents separated from the air flow within said spiral-shaped flow body.

2. The volute of claim 1, wherein said turbomachine includes a turbine.

3. The volute of claim 1, wherein said spiral-shaped flow body has a diameter; and, the diameter decreases in a downstream direction.

4. The volute of claim 1, wherein:
the volute defines an axis;
said spiral-shaped flow body is arranged wound around the axis; and,
said discharge opening is arranged on a radially outer annular portion of said spiral-shaped flow body with respect to the axis.

5. The volute of claim 1, wherein said spiral-shaped flow body has a plurality of discharge openings arranged sequentially in a flow direction.

6. The volute of claim 1 further comprising an air return element for again receiving an air flow part conducted into said discharge opening.

7. The volute of claim 1 further comprising a separating structure arranged in said spiral-shaped flow body for separating the fluid constituents from the air flow and for guiding the fluid constituents to said discharge opening,

8. The volute of claim 1 further comprising an annular channel arranged at the flow inlet.

9. The volute of claim 1 further comprising a valve for controlling the discharge of the fluid constituents from said discharge opening.

10. The volute of claim 1 further comprising a diverting arrangement arranged outside said spiral-shaped flow body for diverting the fluid constituents discharged from said discharge opening.

11. The volute of claim 1, wherein said discharge opening is arranged, in an assembled state, such that the fluid constituents are, in a manner assisted by gravity, at least one of:
guided to said discharge opening; and,
discharged from the discharge opening.

12. The volute of claim 1, wherein the vehicle is a utility vehicle.

13. A turbomachine for a fuel cell system of a vehicle, the turbomachine comprising:
a volute having a flow inlet for applying an air flow including fluid constituents to the volute;
said volute further having a spiral-shaped flow body for guiding the air flow; and,
said spiral-shaped flow body having a discharge opening for discharging from said spiral-shaped flow body the fluid constituents separated from the air flow within said spiral-shaped flow body.

14. The turbomachine of claim 13, wherein the vehicle is a utility vehicle.

15. A fuel cell system comprising:
a turbomachine including a volute having a flow inlet for applying an air flow including fluid constituents to the volute;
said volute further having a spiral-shaped flow body for guiding the air flow;
said spiral-shaped flow body having a discharge opening for discharging from said spiral-shaped flow body the fluid constituents separated from the air flow within said spiral-shaped flow body; and,
a fuel cell stack configured to be operatively connected to said turbomachine.

16. A vehicle comprising the fuel cell system of claim 15.

17. The vehicle of claim 16, wherein the vehicle is a utility vehicle.
